(19) United States
(12) Patent Application Publication
(10) Pub. No.: US 2016/0368126 A1
(43) Pub. Date: Dec. 22, 2016

(54) NAIL GUN

(71) Applicant: BASSO INDUSTRY CORP., Taichung (TW)

(72) Inventors: An-Gi Liu, Taichung (TW); Guey-Horng Liou, Taichung (TW)

(73) Assignee: BASSO INDUSTRY CORP., Taichung (TW)

(21) Appl. No.: 15/184,268

(22) Filed: Jun. 16, 2016

(30) Foreign Application Priority Data
Jun. 18, 2015 (TW) 104209862

(51) Int. Cl. B25C 1/00

(52) U.S. Cl. CPC B25C 1/008

(57) ABSTRACT

A nail gun includes a gun body, a safety unit, a detecting member and a blocking unit. The gunbody defines a firing path and a guiding groove therein. The safety unit is movable relative to the gun body. The detecting member and the blocking unit are disposed on the firing seat. When both the firing path and the guiding groove receive nail therein, the detecting member abuts against the nail in the guiding groove and is spaced apart from the nail in the firing path, and the blocking unit permits the movement of the safety member relative to the gun body. When the firing path and the guiding groove are empty, the detecting member is inserted into the firing path, and the blocking unit hinders the movement of the safety member relative to the gun body.

### CROSS-REFERENCE TO RELATED APPLICATION

This application claims priority of Taiwanese Patent Application No. 104209862, filed on Jun. 18, 2015.

### FIELD

The disclosure relates to a nail gun, and more particularly to a nail gun that is prevented from dry firing.

### BACKGROUND

Referring to FIGS. 1 and 2, a conventional nail gun 1 disclosed in Taiwanese Patent No. I325810 includes a gun body 100, a firing path 11 formed in the gun body 100 for receiving a nail 10 that is to be fired, a guiding groove 12 formed in the gun body 100 and being in spatial communication with the firing path 11 for receiving a plurality of nails 10 that are moved into the firing path 11 one at a time, a safety member 13 movable relative to the gun body 100 for being operated before firing the nail 10 received in the firing path 11, a lever member 14 pivoted to the gun body 100, and a resilient member 15. The lever member 14 has a detecting portion 141 and a blocking portion 142. The resilient member 15 resiliently biases the lever member 14 for moving the detecting portion 141 into the firing path 11. When the firing path 11 is empty (see FIG. 2), the detecting portion 141 is moved into the firing path 11 by the resilient member 15, such that the blocking portion 142 is configured to prevent the movement of the safety member 13 relative to the gun body 100 so as to prevent firing operation of the conventional nail gun 1. When the firing path 11 receives a nail 10 therein (see FIG. 1), the detecting portion 141 is pushed by the nail 10 in the firing path 11 to move away from the firing path 11 against the biasing action of the resilient member 15, such that the blocking portion 142 is configured not to prevent the movement of the safety member 13 relative to the gun body 100 so as to permit the firing operation of the conventional nail gun 1.

However, the detecting portion 141 of the lever member 14 is constantly in contact with the nail 10 received in the firing path 11 to generate a frictional force to retard movement of the nail 10, thereby affecting adversely smooth firing operation of the conventional nail gun 1.

### SUMMARY

Therefore, an object of the disclosure is to provide a nail gun that can alleviate the drawback of the prior art.

According to the disclosure, the nail gun is for sequentially firing a plurality of nails. Each of the nails has a head and a body. The nail gun includes a gun body, a magazine, a safety unit, a detecting member, a blocking unit and a resilient member. The gun body includes a firing seat that defines a firing path and a guiding groove therein. The guiding groove is in spatial communication with the firing path. The magazine is for receiving the nails therein, and is connected to the firing seat such that the nails can be moved from the guiding groove into the firing path one at a time. The safety unit is disposed on the gun body, and is movable relative to the firing seat in a moving direction between a normal position where firing operation of the nail gun is not permitted, and a depressed position where the firing operation of the nail gun is permitted. The detecting member is disposed on the firing seat, and has a detecting portion that is pivotable relative to the firing seat and that is resiliently biased into the firing path. When the firing path receives one of the nails therein and the guiding groove receives at least one of the nails therein, the detecting portion is at a multi-nail position where the detecting portion abuts against the body of the nail received in the guiding groove, and is spaced apart from the nail received in the firing path. When the firing path receives one of the nails therein and the guiding groove is empty, the detecting portion is at a single-nail position where the detecting portion abuts against the head of the nail received in the firing path. When the firing path and the guiding groove are empty, the detecting portion is at a null position where the detecting portion is inserted into the firing path. The blocking unit is pivoted to the firing seat, and has a blocking portion and an urging portion. The urging portion is in contact with the detecting portion of the detecting member. When the detecting portion of the detecting member is at the multi-nail position or at the single nail position, the blocking portion is misaligned from the safety unit in the moving direction so as to permit the safety unit to move to the depressed position. When the detecting portion of the detecting member is at the null position, the blocking portion is aligned with the safety unit in the moving direction so as to prevent the safety unit from moving to the depressed position. The resilient member is disposed between the blocking unit and the firing seat, and resiliently biases the urging portion of the blocking unit to abut against the detecting portion of the detecting member.

### BRIEF DESCRIPTION OF THE DRAWINGS

Other features and advantages of the disclosure will become apparent in the following detailed description of the embodiment with reference to the accompanying drawings, of which:

FIG. 1 is a sectional view illustrating a conventional nail gun disclosed in Taiwanese Patent No. I325810;

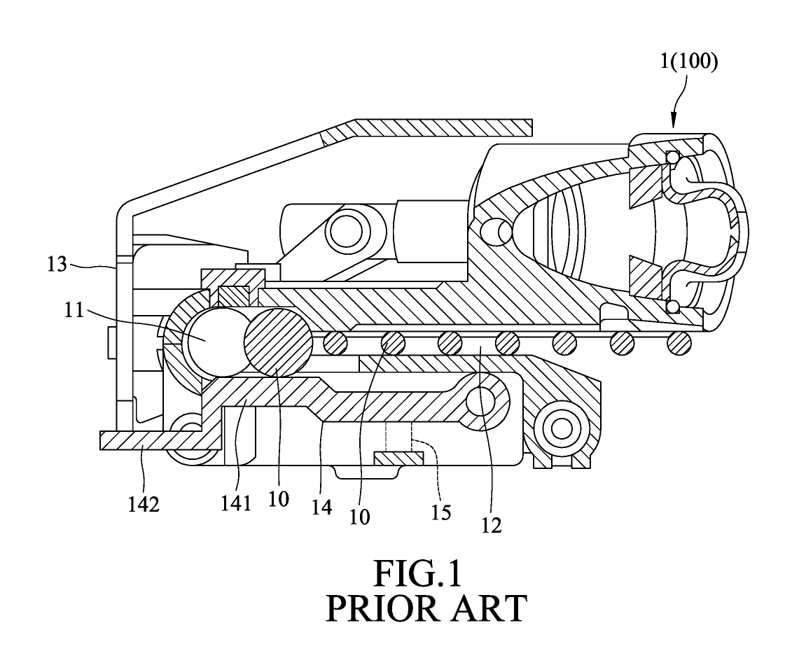

FIG. 2 is another sectional view illustrating the conventional nail gun;

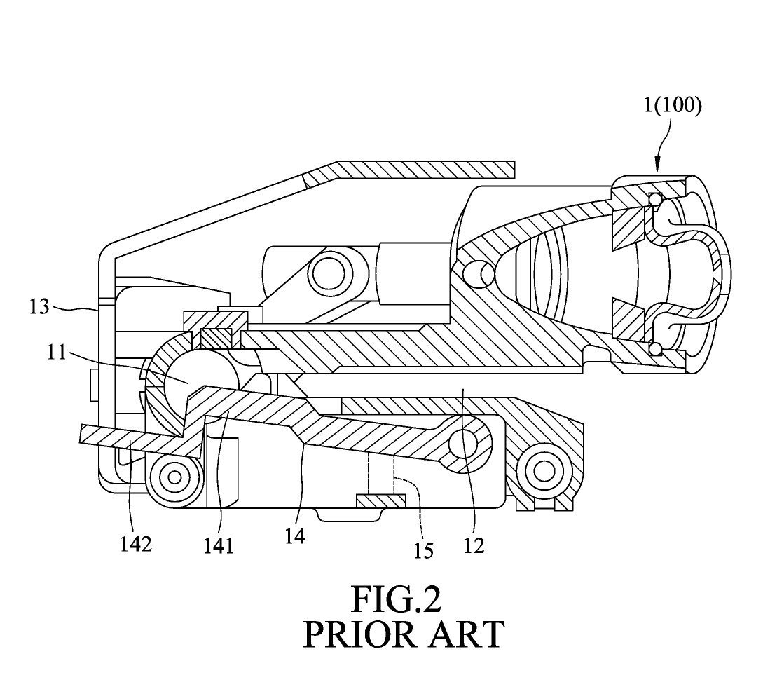

FIG. 3 is a fragmentary side view illustrating an embodiment of the nail gun according to the disclosure;

FIG. 4 is an exploded perspective view illustrating the embodiment;

FIG. 5 is a schematic perspective cutaway view illustrating a detecting member of the embodiment at a multi-nail position;

FIG. 6 is another schematic perspective cutaway view illustrating the detecting member at the multi-nail position;

FIG. 7 is still another schematic perspective cutaway view illustrating the detecting member at the multi-nail position and being spaced apart from a nail received in a firing path of the embodiment;

FIG. 8 is still another schematic perspective cutaway view illustrating the detecting member at a single-nail position;

FIG. 9 is still another schematic perspective cutaway view illustrating the detecting member at the single-nail position and being in contact with the nail received in the firing path; and

FIG. 10 is still another schematic perspective cutaway view illustrating the detecting member at a null position.

### DETAILED DESCRIPTION

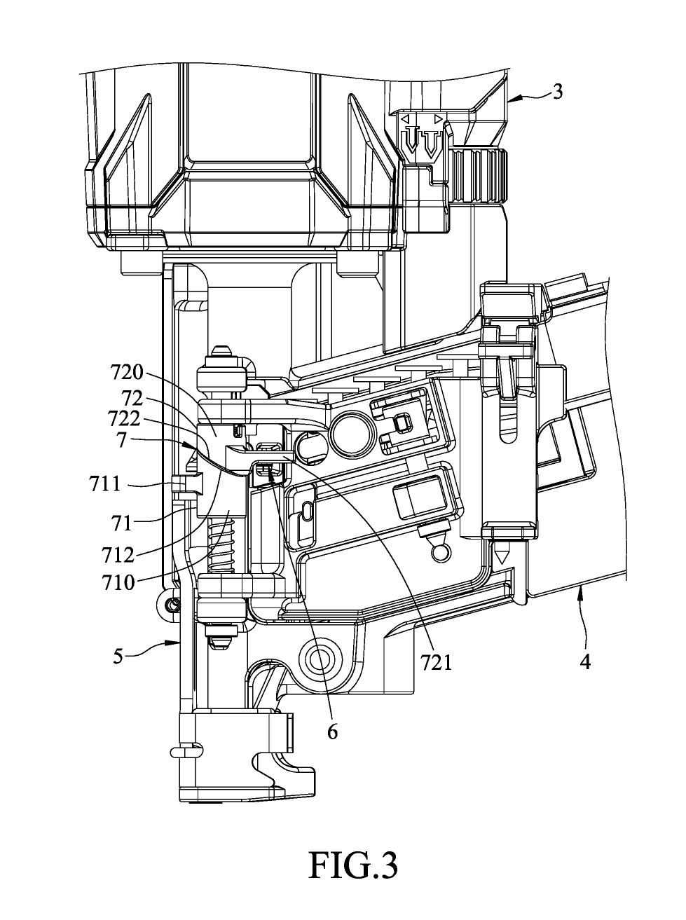

Referring to FIGS. 3 to 5, the embodiment of the nail gun according to the disclosure is for sequentially firing a plurality of nails 2, and includes a gun body 3, a magazine 4, a safety unit 5, a detecting member 6, a blocking unit 7, a resilient member 8 and a magnetic member 9. Each of the nails 2 has a head 21 and a body 22.

The gun body 3 includes a firing seat 31. The firing seat 31 includes a seat body 311, and a cap member 312 that is connected to the seat body 311 and that cooperates with the seat body 311 to define a firing path 32 and a guiding groove 33 therebetween. The firing path 32 extends in a firing direction. The guiding groove 33 is in spatial communication with the firing path 32, and extends in a direction perpendicular to the firing direction.

The magazine 4 is for receiving the nails 2 therein, and is inserted into the guiding groove 33 of the firing seat 31 such that, the nails 2 can be moved from the guiding groove 33 into the firing path 32 one at a time.

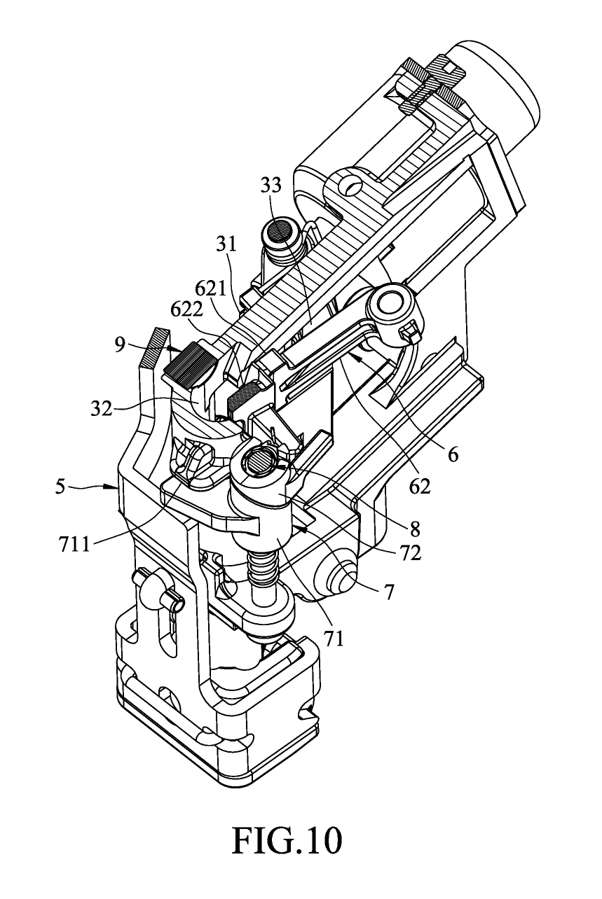

The safety unit 5 is disposed on the gun body 3, and is movable relative to the firing seat 31 in a moving direction between a normal position (see FIG. 10) where firing operation of the nail gun is not permitted, and a depressed position (not shown) where the firing operation of the nail gun is permitted.

The detecting member 6 has a pivoted portion 61 that is pivoted to the cap member 312 of the firing seat 31, and a detecting portion 62 that extends from the pivoted portion 61. The detecting portion 62 has a first detecting surface 621 that faces and corresponds in position to the guiding groove 33, a second detecting surface 622 that faces and corresponds in position to the firing path 32 and that is offset from the first detecting surface 621, and a projection 623 that projects away from the firing path 32. The detecting member 6 is resiliently biased to move the second detecting surface 622 into the firing path 32.

The blocking unit 7 includes a blocking member 71 and a linking member 72. The blocking member 71 and the linking member 72 are co-axially pivoted to the cap member 312 of the firing seat 31, and are disposed adjacent to the firing path 312. The blocking member 71 has a pivoted portion 710 that is pivoted to the cap member 312, a blocking portion 711 that is formed on an outer surface of the pivoted portion 710, and a first inclined surface 712 that faces the linking member 72 and that has an abutment surface portion 7121. The linking member 72 has a pivoted portion 720 that is pivoted to the cap member 312, an urging portion 721 that is formed on an outer surface of the pivoted portion 720 and that is in contact with the projection 623 of the detecting member 6, a second inclined surface 722 that faces the blocking member 71 and that is in slidable contact with the first inclined surface 712 of the blocking member 71, and a driving block 7221 that is formed on the second inclined surface 722.

The resilient member 8 in this embodiment is configured as a torsion spring, is disposed between the blocking unit 7 and the firing seat 31, and has a first end section 81 that abuts against the pivoted portion 720 of the linking member 72, and a second end section 82 that abuts against the cap member 312 of the firing seat 31, so as to resiliently bias the urging portion 721 of the linking member 72 to abut against the projection 623 of the detecting member 6.

The magnetic member 9 is mounted to the firing seat 31, and corresponds in position to the head 21 of the nail 2 that is received in the firing path 32.

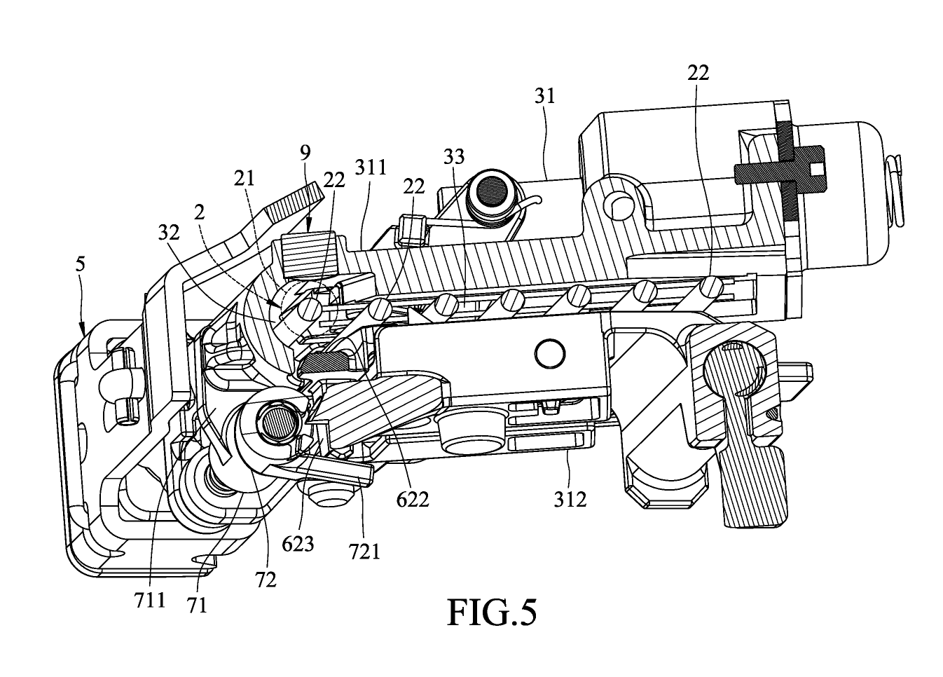

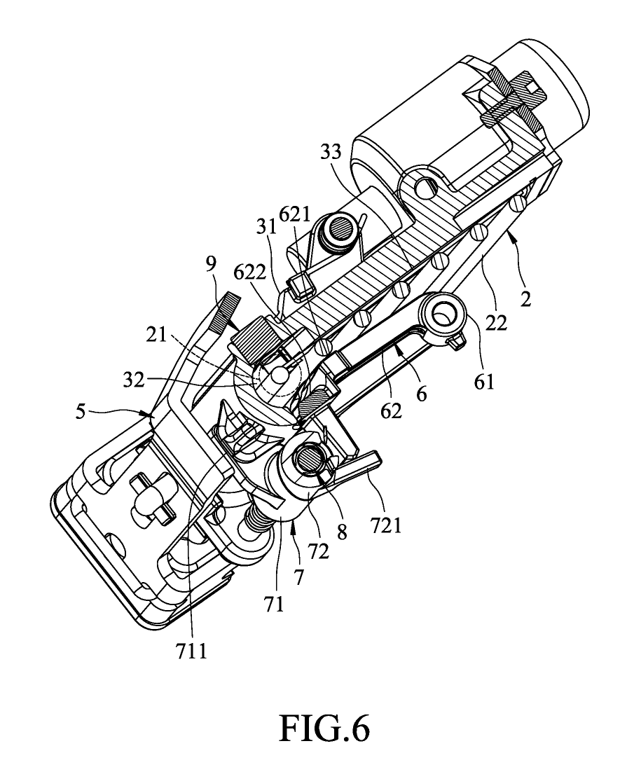

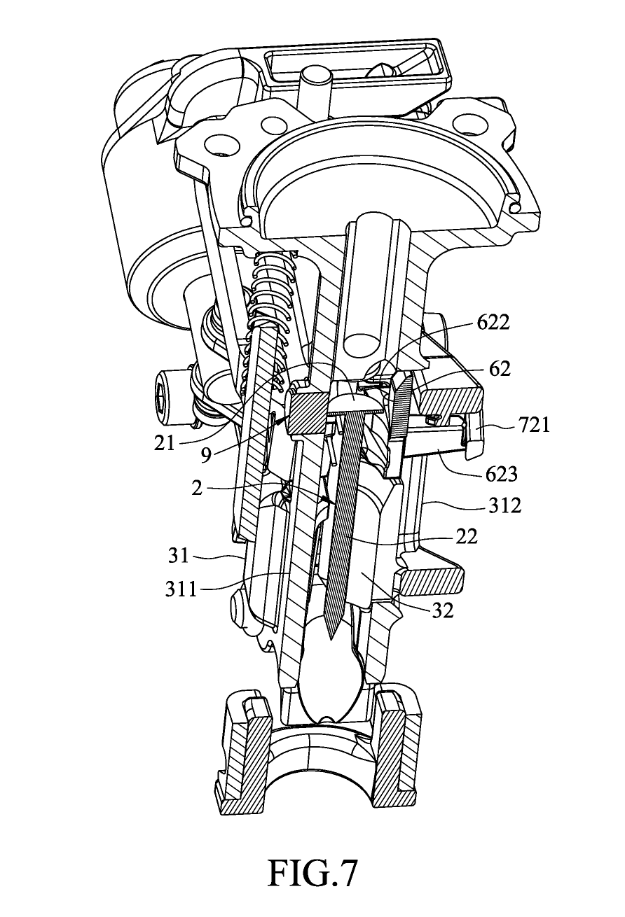

Referring to FIGS. 5 to 7, when the firing path 32 receives a nail 2 therein and the guiding groove 33 receives at least one nail 2 therein, the detecting portion 62 of the detecting member 6 is at a multi-nail position where the first detecting surface 621 abuts against the body 22 of the nail 2 received in the guiding groove 33 and where the second detecting surface 622 is spaced apart from the head 21 of the nail 2 received in the firing path 32. In this embodiment, when the guiding groove 33 receives a plurality of nails 2 therein, the first detecting surface 621 abuts against the body 22 of one of the nails 2 received in the guiding groove 33 that is closest to the firing path 32.

At this time, the urging portion 721 of the linking member 72 abuts against the projection 623 of the detecting member 6, and the blocking portion 711 of the blocking member 71 is misaligned from the safety unit 5 in the moving direction, so that the safety unit 5 is permitted to move to the depressed position to thereby permit the firing operation of the nail gun.

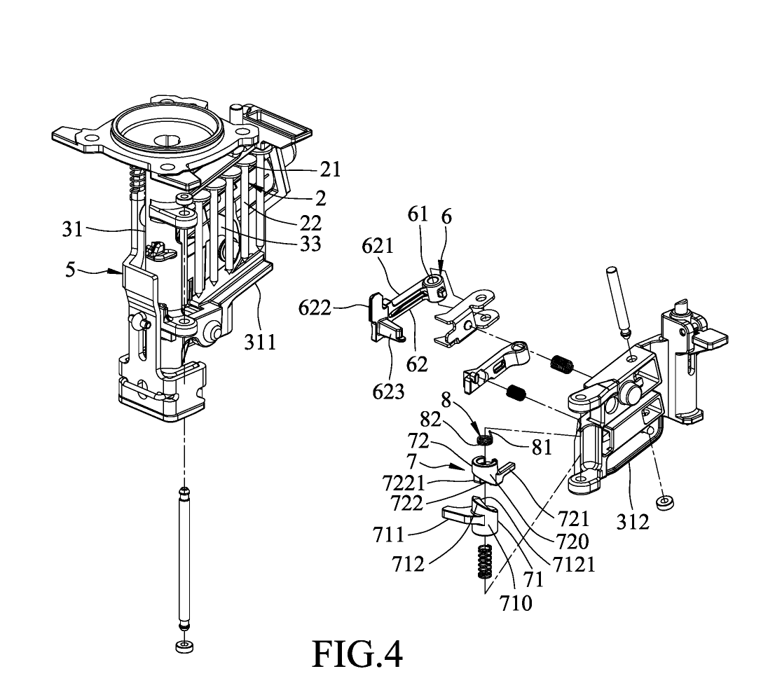

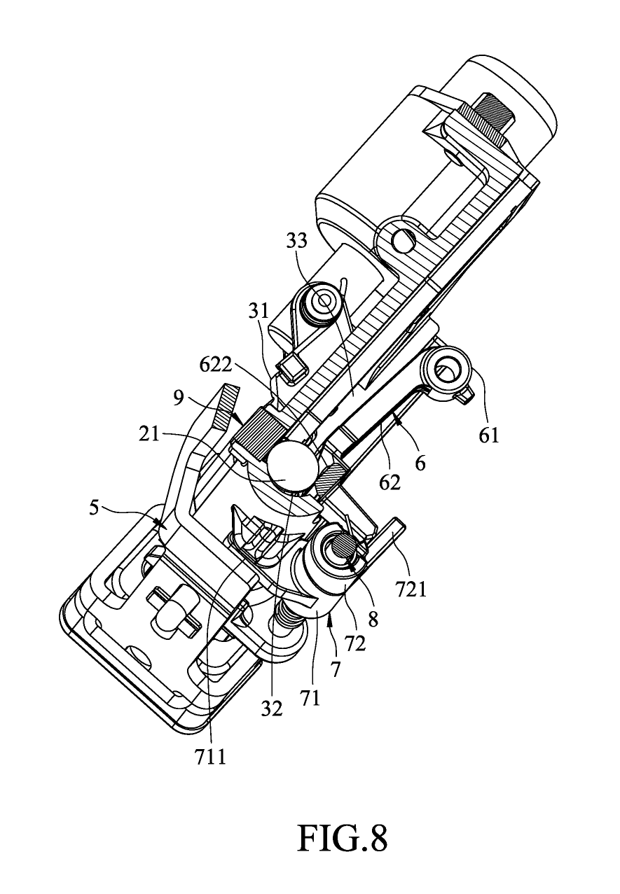

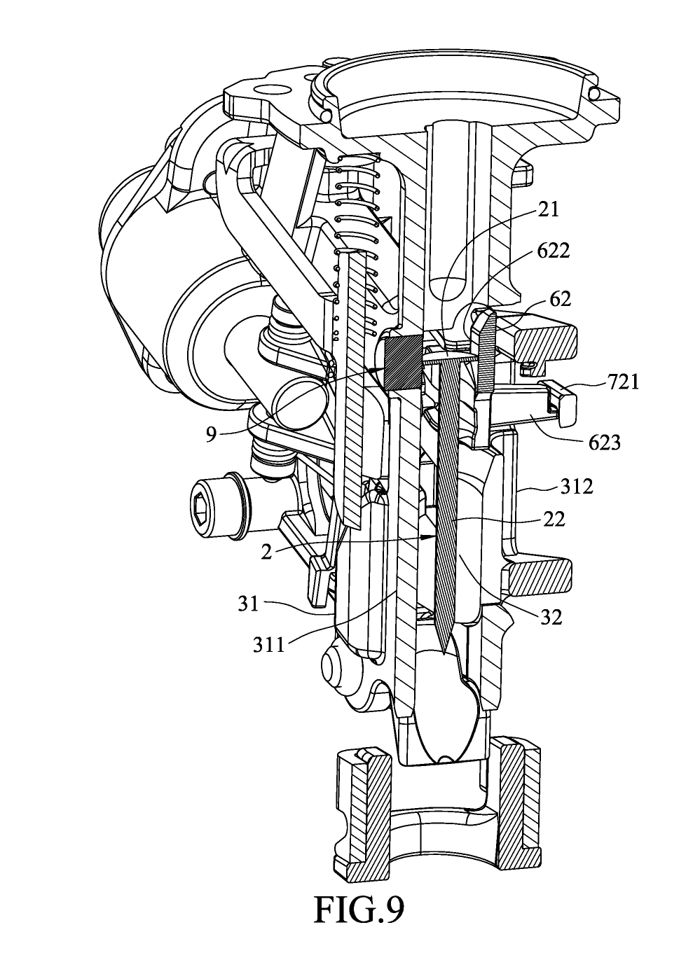

Referring to FIGS. 4, 8 and 9, when the firing path 32 receives a nail 2 therein and the guiding groove 33 is empty, the detecting portion 62 of the detecting member 6 is biased to move to a single-nail position where the second detecting surface 622 abuts against the head 21 of the nail 2 received in the firing path 32 and is prevented from being moved into the firing path 32. At this time, the head 21 of the nail 2 received in the firing path 32 is magnetically attracted by the magnetic member 9 so that the nail 2 is able to be steadily positioned in the firing path 32.

During the movement of the detecting portion 62 of the detecting member 6 from the multi-nail position to the single-nail position, the resilient member 8 resiliently rotates the linking member 72 so that the urging portion 721 of the linking member 72 is maintained to abut against the projection 623 of the detecting member 6, and that the driving block 7221 is moved to be in contact with the abutment surface portion 7121 of the blocking member 71. When the detecting portion 62 of the detecting member 6 is at the single-nail position, the blocking portion 711 of the blocking member 71 is still misaligned from the safety unit 5 in the moving direction so as to permit the safety unit 5 to move to the depressed position.

Referring to FIG. 10, when the firing path 32 and the guiding groove 33 are empty, the detecting portion 62 of the detecting member 6 is biased to move to a null position where the second detecting surface 622 is moved into the firing path 32.

During the movement of the detecting portion 62 of the detecting member 6 from the single-nail position to the null position, the resilient member 8 resiliently rotates the linking member 72 so that the urging portion 721 of the linking member 72 is maintained to abut against the projection 623 of the detecting member 6, and that the driving block 7221 is moved to push the abutment surface portion 7121 of the blocking member 71 to thereby rotate the blocking member 71 to align the blocking portion 711 with the safety unit 5 in the moving direction. As such, when the detecting portion 62 of the detecting member 6 is at the null position, the blocking portion 711 of the blocking member 71 blocks the safety unit 5 from moving to the depressed position, so as to prevent the firing operation of the nail gun.

In summary, since the second detecting surface 622 is spaced apart from the head 21 of the nail 2 received in the firing path 32 when the detecting portion 62 of the detecting member 6 is at the multi-nail position, movement of the nail 2 in the firing path 32 during the firing operation of the nail gun would not be retarded by the detecting member 6.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A nail gun adapted for sequentially firing a plurality of nails, each of the nails having a head and a body, said nail gun comprising:
a gun body including a firing seat that defines a firing path and a guiding groove therein, said guiding groove being in spatial communication with said firing path;
a magazine adapted for receiving the nails therein, and connected to the firing seat such that the nails can be moved from the guiding groove into the firing path one at a time;
a safety unit disposed on said gun body, and movable relative to said firing seat in a moving direction between a normal position where firing operation of said nail gun is not permitted, and a depressed position where the firing operation of said nail gun is permitted;
a detecting member disposed on said firing seat, and having a detecting portion that is pivotable relative to said firing seat and that is resiliently biased into said firing path such that : when said firing path receives one of the nails therein and when said guiding groove receives at least one of the nails therein, said detecting portion is at a multi-nail position where said detecting portion is adapted to abut against the body of the nail received in said guiding groove, and is adapted to be spaced apart from the nail received in said firing path; when said firing path receives one of the nails therein and when said guiding groove is empty, said detecting portion is at a single-nail position where said detecting portion is adapted to abut against the head of the nail received in said firing path; and when said firing path and said guiding groove are empty, said detecting portion is at a null position where said detecting portion is inserted into said firing path;
a blocking unit pivoted to said firing seat, and having a blocking portion and an urging portion, said urging portion being in contact with said detecting portion of said detecting member such that, when said detecting portion of said detecting member is at the multi-nail position or at the single nail position, said blocking portion is misaligned from said safety unit in the moving direction so as to permit said safety unit to move to the depressed position, and when said detecting portion of said detecting member is at the null position, said blocking portion is aligned with said safety unit in the moving direction so as to prevent said safety unit from moving to the depressed position; and
a resilient member disposed between said blocking unit and said firing seat, and resiliently biasing said urging portion of said blocking unit to abut against said detecting portion of said detecting member.

2. The nail gun as claimed in claim 1, wherein said firing seat includes a seat body, and a cap member that is connected to said seat body and that cooperates with said seat body to define said firing path and said guiding groove therebetween, said detecting member having a pivoted portion that is pivoted to said cap member, said detecting portion of said detecting member being connected to said pivoted portion.

3. The nail gun as claimed in claim 1, wherein said detecting portion of said detecting member has a first detecting surface that faces and corresponds in position to said guiding groove and that is adapted for abutting against the nail received in said guiding groove, and a second detecting surface that faces and corresponds in position to said firing path and that is offset from said first detecting surface and that is adapted for abutting against the nail received in said firing path.

4. The nail gun as claimed in claim 3, further comprising a magnetic member that is mounted in said firing seat and that is adapted for magnetically attracting the head of the nail received in said firing path.

5. The nail gun as claimed in claim 1, wherein said blocking unit includes a linking member that has said urging port ion, and a blocking member that is in slidable contact with said linking member and that has said blocking portion.

6. The nail gun as claimed in claim 5, wherein one of said linking member and said blocking member has an inclined surface that has an abutment surface portion, the other one of said linking member and said blocking member having an inclined surface that is in slidable contact with said inclined surface of the one of said linking member and said blocking member, and a driving block that is formed on said inclined surface thereof, such that during the movement of said detecting portion from the single-nail position to the null position, said resilient member resiliently rotates said linking member to maintain the contact between said urging portion and said detecting port ion, so that said driving block and said abutment surface portion are pushed against each other to rotate said blocking member to align said blocking portion with said safety unit in the moving direction.

7. The nail gun as claimed in claim 6, wherein said resilient member is configured as a torsion spring, and has a first end section that abuts against said linking member, and a second end section that abuts against said gun body.
